(19) United States
(12) Patent Application Publication
(10) Pub. No.: US 2022/0162085 A1
(43) Pub. Date: May 26, 2022

(54) NANOPARTICLES FOR PHOTOCHROMIC MATERIAL AND AQUEOUS DISPERSION OF NANOPARTICLES FOR PHOTOCHROMIC MATERIAL

(71) Applicant: THE RITSUMEIKAN TRUST, Kyoto (JP)

(72) Inventors: Yoichi KOBAYASHI, Shiga (JP); Yulian HAN, Shiga (JP)

(73) Assignee: THE RITSUMEIKAN TRUST, Kyoto (JP)

(21) Appl. No.: 17/434,146

(22) PCT Filed: Feb. 18, 2020
(86) PCT No.: PCT/JP2020/006330

§ 371 Date: Aug. 26, 2021

(30) Foreign Application Priority Data
Feb. 27, 2019 (JP) 2019-033852

(51) Int. Cl. C01G 9/08

(52) U.S. Cl. CPC C01G 9/08; C01P 2004/04; B82Y 20/00; C01P 2004/64; C01P 2006/60; C01P 2004/32

(57) ABSTRACT

Provided is a nanoparticle for photochromic materials that enables the production of photochromic materials in which the reaction time of a photochromic reaction is short.

The nanoparticle for photochromic materials is represented by the following formula (1):

ZnX (1),
wherein X represents a Group 16 element,
the nanoparticle being doped with and/or having, adsorbed thereto, a transition metal,
the nanoparticle having organic ligands containing elemental sulfur on the surface thereof.

### TECHNICAL FIELD

The present invention relates to nanoparticles for photochromic materials, and an aqueous dispersion of nanoparticles for photochromic materials.

### BACKGROUND ART

In recent years, so-called photochromic materials, in which the materials are colored when irradiated with light of a specific wavelength, the color disappears when the irradiation is stopped, and the color change is repeated, have been investigated.

Photochromic materials can be used in various fields. In particular, photochromic materials are useful for eyewear, such as eyeglasses, sunglasses, and goggles, because they can protect the eyes and ensure visibility under sunlight irradiation or the like.

As a result of extensive research, the present inventors found that semiconductor nanoparticles can be used as a photochromic material.

As semiconductor nanoparticles, those with a core/shell structure have been proposed; and a method for producing a semiconductor nanoparticle aggregate containing such semiconductor nanoparticles has been proposed (see, for example, Patent Literature (PTL) 1).

However, PTL 1 does not disclose ZnS semiconductor nanoparticles. Since no photochromic reaction is observed using the semiconductor nanoparticles of PTL 1, the semiconductor nanoparticles of PTL 1 cannot be used as a photochromic material.

Moreover, products using photochromic materials, such as the eyewear described above, are desired to reach a state suitable for a situation in a short period of time; and photochromic materials are required to have a short reaction time from irradiation with light to coloration, and from coloration to returning to the original state.

Thus, there is a need to develop nanoparticles for photochromic materials that enable the production of photochromic materials in which the reaction time of a photochromic reaction is short.

### CITATION LIST

### Patent Literature

PTL 1: JP5915529B

### SUMMARY OF INVENTION

### Technical Problem

An object of the present invention is to provide nanoparticles for photochromic materials that enable the production of photochromic materials in which the reaction time of a photochromic reaction is short.

### Solution to Problem

The present inventors conducted extensive research, and found that the above object can be achieved by a nanoparticle for photochromic materials represented by formula ZnX, wherein X represents a Group 16 element; the nanoparticle being doped with and/or having, adsorbed thereto, a transition metal; and the nanoparticle having organic ligands containing elemental sulfur on the surface thereof. The present invention has been accomplished based on this finding.

Specifically, the present invention relates to the following nanoparticle for photochromic materials and aqueous dispersion of nanoparticles for photochromic materials.

1. A nanoparticle for photochromic materials, the nanoparticle being represented by the following formula (1):

ZnX (1),
wherein X represents a Group 16 element,
the nanoparticle being doped with and/or having, adsorbed thereto, a transition metal,
the nanoparticle having organic ligands containing elemental sulfur on the surface thereof.

2. The nanoparticle for photochromic materials according to Item 1, wherein X is at least one member selected from the group consisting of O, S, Se, and Te.

3. The nanoparticle for photochromic materials according to Item 1 or 2, wherein the organic ligands are represented by the following formula (2):

—S—R—COOH (2),
wherein R represents a C₁-C₂₀ organic group.

4. The nanoparticle for photochromic materials according to any one of Items 1 to 3, which has an average particle size of 1 nm or more and 100 nm or less.

5. An aqueous dispersion of nanoparticles for photochromic materials, comprising the nanoparticles for photochromic materials according to any one of Items 1 to 4 dispersed in water.

### Advantageous Effects of Invention

The nanoparticles for photochromic materials of the present invention enable the production of photochromic materials in which the reaction time of a photochromic reaction is short.

### BRIEF DESCRIPTION OF DRAWINGS

FIG. 1 schematically shows an example of the structure of the nanoparticles for photochromic materials of the present invention.

FIG. 2 shows the measurement results of XRD (X-ray diffraction) of the nanoparticles for photochromic materials of Example 1.

FIG. 3 shows the measurement results of absorbance change in 500 nm spectra when the nanoparticles for photochromic materials obtained in Example 1 and Comparative Example 1 are irradiated with ultraviolet light.

FIG. 4 shows photographs of the state of the nanoparticles for photochromic materials of Example 1 after ultraviolet light irradiation.

FIG. 5 shows the measurement results of absorbance change in a spectrum in the range of 300 to 800 nm 1 second after ultraviolet light irradiation of the nanoparticles for photochromic materials of Example 1.

FIG. 6 shows the measurement results of absorbance change in a spectrum in the range of 300 to 800 nm 10 seconds after ultraviolet light irradiation of the nanoparticles for photochromic materials of Example 1.

FIG. 7 shows the measurement results of absorbance change in a spectrum in the range of 300 to 800 nm 40 seconds after ultraviolet light irradiation of the nanoparticles for photochromic materials of Example 1.

FIG. 8 shows the measurement results of absorbance change in a spectrum in the range of 300 to 800 nm 1 second after ultraviolet light irradiation of the nanoparticles for photochromic materials of Comparative Example 2.

FIG. 9 shows the measurement results of absorbance change in a spectrum in the range of 300 to 800 nm 10 seconds after ultraviolet light irradiation of the nanoparticles for photochromic materials of Comparative Example 2.

FIG. 10 shows the measurement results of absorbance change in a spectrum in the range of 300 to 800 nm 40 seconds after ultraviolet light irradiation of the nanoparticles for photochromic materials of Comparative Example 2.

FIG. 11 shows the measurement results of absorbance change in a spectrum in the range of 300 to 800 nm 1 second after ultraviolet light irradiation of the nanoparticles for photochromic materials of Comparative Example 3.

FIG. 12 shows the measurement results of absorbance change in a spectrum in the range of 300 to 800 nm 10 seconds after ultraviolet light irradiation of the nanoparticles for photochromic materials of Comparative Example 3.

FIG. 13 shows the measurement results of absorbance change in a spectrum in the range of 300 to 800 nm 40 seconds after ultraviolet light irradiation of the nanoparticles for photochromic materials of Comparative Example 3.

FIG. 14 shows the measurement results of absorbance change in a spectrum in the range of 300 to 800 nm 1 second after ultraviolet light irradiation of the nanoparticles for photochromic materials of Example 3.

FIG. 15 shows the measurement results of absorbance change in a spectrum in the range of 300 to 800 nm 10 seconds after ultraviolet light irradiation of the nanoparticles for photochromic materials of Example 3.

FIG. 16 shows the measurement results of absorbance change in a spectrum in the range of 300 to 800 nm 40 seconds after ultraviolet light irradiation of the nanoparticles for photochromic materials of Example 3.

FIG. 17 shows the measurement results of electron paramagnetic resonance (EPR) of the nanoparticles for photochromic materials of Example 1.

FIG. 18 shows the measurement results of electron paramagnetic resonance (EPR) of the nanoparticles for photochromic materials of Example 2.

FIG. 19 shows the measurement results of electron paramagnetic resonance (EPR) of the nanoparticles for photochromic materials of Example 3.

FIG. 20 shows the measurement results of electron paramagnetic resonance (EPR) of the nanoparticles for photochromic materials of Comparative Example 1.

FIG. 21 shows the measurement results of absorbance change 200 nanoseconds after irradiation of an aqueous dispersion of the nanoparticles for photochromic materials of Example 2 with a picosecond pulsed laser.

FIG. 22 shows the measurement results of absorbance change 600 nanoseconds after irradiation of an aqueous dispersion of the nanoparticles for photochromic materials of Example 2 with a picosecond pulsed laser.

FIG. 23 shows the measurement results of absorbance change 1800 nanoseconds after irradiation of an aqueous dispersion of the nanoparticles for photochromic materials of Example 2 with a picosecond pulsed laser.

FIG. 24 shows the measurement results of absorbance change in aqueous dispersions of the nanoparticles for photochromic materials of Example 1 and Comparative Example 1 irradiated with a picosecond pulsed laser and probed at a wavelength of 600 nm.

FIG. 25 shows the results of the nanoparticles for photochromic materials of Example 2 observed with a transmission electron microscope (TEM).

FIG. 26 shows the results of the nanoparticles for photochromic materials of Example 2 observed with a transmission electron microscope (TEM).

FIG. 27 shows the measurement results of light resistance of the nanoparticles for photochromic materials of Example 1.

FIG. 28 shows the results of absorption spectrum measurement of the nanoparticles for photochromic materials of Example 1 and Comparative Example 1.

FIG. 29 shows the results of IR spectrum measurement of the nanoparticles for photochromic materials of Example 1 before and after drying.

FIG. 30 shows the measurement results of absorbance change in the nanoparticles for photochromic materials of Example 1 before and after drying.

FIG. 31 shows the measurement results of absorbance change in the nanoparticles for photochromic materials of Example 1 under different temperature conditions.

### DESCRIPTION OF EMBODIMENTS

### 1. Nanoparticle for Photochromic Materials

The nanoparticle for photochromic materials of the present invention is represented by the following formula (1):

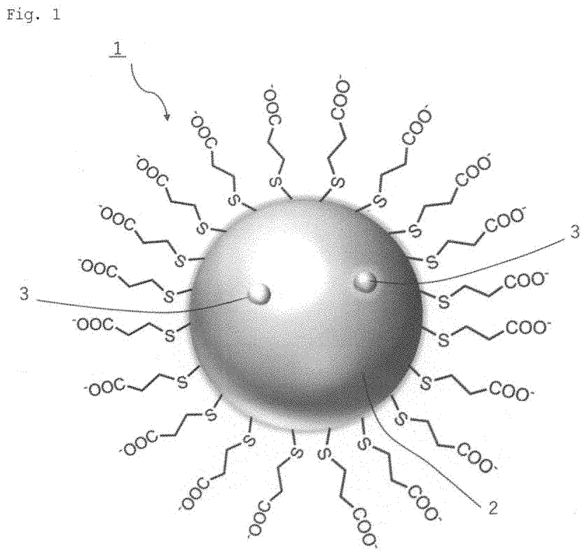

ZnX (1)
wherein X represents a Group 16 element,
the nanoparticle being doped with and/or having, adsorbed thereto, a transition metal, the nanoparticle having organic ligands containing elemental sulfur on the surface thereof. FIG. 1 schematically shows an example of the structure of the nanoparticle for photochromic materials of the present invention in the case in which X in formula (1) is S, the doping transition metal is Cu, and the organic ligands are —S—C₂H₄—COOH. The terminal carboxyl groups of the organic ligands are present in a state of —COO⁻ in an aqueous solution. In FIG. 1, nanoparticle 1 for photochromic materials of the present invention has a structure in which ZnS nanoparticle 2 is doped with Cu as transition metal 3, and has —S—C₂H₄—COO⁻ as organic ligands containing elemental sulfur on the surface of the particle.

The nanoparticle for photochromic materials of the present invention, which has the above features, has a structure represented by formula (1) and can function as a so-called photochromic material, in which the material is colored when irradiated with light of a specific wavelength, the color disappears when the irradiation is stopped, and the color change is repeated. Moreover, since the nanoparticle for photochromic materials of the present invention is doped with and/or has, adsorbed thereto, a transition metal, and has organic ligands containing elemental sulfur on the surface thereof, the reaction time from irradiation with light to coloration and from coloration to returning to the original state is shortened, making it possible to produce photochromic materials in which the reaction time of a photochromic reaction is short.

The present invention is described in detail below.

The nanoparticle for photochromic materials of the present invention is represented by the following formula (1):

ZnX (1).

In formula (1), X represents a Group 16 element. Specific examples of X include O, S, Se, and Te. Among these, S and O are preferable, and S is more preferable, because the coloration upon irradiation with light is much more distinct.

As X, a single Group 16 element may be used, or two or more Group 16 elements may be used in combination.

The nanoparticle for photochromic materials of the present invention is doped with and/or has, adsorbed thereto, a transition metal. Specifically, when the nanoparticle for photochromic materials of the present invention is doped with a transition metal, a part of the Zn is replaced by the transition metal in the particle core represented by ZnX. When a transition metal is adsorbed to the nanoparticle for photochromic materials of the present invention, the transition metal is adsorbed on the surface of the particle core represented by ZnX. The nanoparticle for photochromic materials of the present invention may be doped with a transition metal, may have a transition metal adsorbed thereto, or may be partially doped with a transition metal and partially have a transition metal adsorbed thereto.

Examples of the transition metal include, but are not particularly limited to, manganese, cobalt, nickel, iron, chromium, copper, molybdenum, vanadium, titanium, zirconium, niobium, silver, bismuth, and the like. Among these, copper is preferable because the coloration upon irradiation with light is much more distinct.

The transition metals may be used singly, or in a combination of two or more.

The doping amount of transition metal is preferably 0.1 mol % or more, and more preferably 0.5 mol % or more, based on the total number of moles of elemental Zn and transition metal element taken as 100 mol %. The doping amount of transition metal is also preferably 10 mol % or less, and more preferably 5 mol % or less. A lower limit of the doping amount of transition metal within the above range makes the coloration upon irradiation with light much more distinct. Moreover, a lower limit of the doping amount of transition metal within the above range further increases the amount of color change.

The adsorption of the transition metal is not particularly limited as long as the transition metal can be adsorbed on the surface of the particle core represented by ZnX, and physical adsorption is preferable. In the nanoparticle for photochromic materials of the present invention, the form of physical adsorption is not clear, and examples thereof include a form in which the transition metal is adsorbed on the surface of the particle core represented by ZnX by van der Waals forces or other electrical effects.

The amount of transition metal adsorbed is preferably 0.1 mass % or more, and more preferably 0.5 mass % or more, based on the nanoparticle for photochromic materials taken as 100 mass %. The amount of transition metal adsorbed is also preferably 10 mass % or less, and more preferably 5 mass % or less. A lower limit of the amount of transition metal adsorbed within the above range makes the coloration upon irradiation with light much more distinct. Moreover, a lower limit of the amount of transition metal adsorbed within the above range further increases the amount of color change.

### Organic Ligand

The nanoparticle for photochromic materials of the present invention has organic ligands containing elemental sulfur on the surface thereof. The organic ligands are not particularly limited, and examples include an organic ligand represented by the following formula (2):

—S—R—COOH (2).

In formula (2), R is a C₁-C₂₀ organic group. R is not particularly limited as long as the number of carbon atoms is within the above range, and examples include aliphatic hydrocarbon groups, aromatic hydrocarbon groups, alicyclic hydrocarbon groups, and the like.

Examples of aliphatic hydrocarbon groups include linear hydrocarbon groups, branched hydrocarbon groups, and alicyclic hydrocarbon groups. Among these, linear hydrocarbon groups and branched hydrocarbon groups are preferable in terms of further increasing the amount of color change.

R may also contain an element other than carbon, such as nitrogen, sulfur, or oxygen.

The number of carbon atoms in R is preferably 1 or more. The number of carbon atoms in R is also preferably 20 or less, more preferably 12 or less, and even more preferably 6 or less. A lower limit of the number of carbon atoms in R within the above range further increases the amount of color change. Moreover, an upper limit of the number of carbon atoms in R within the above range further increases the amount of color change. It is particularly preferred that the number of carbon atoms in R is 2, i.e., that the organic ligands are represented by the following formula:

—S—C₂H₄—COOH.

The average particle size of the nanoparticles for photochromic materials of the present invention is preferably 1 nm or more, and more preferably 2 nm or more. The average particle size of the nanoparticles for photochromic materials of the present invention is also preferably 100 nm or less, and more preferably 10 nm or less. A lower limit of the average particle size within the above range further increases the amount of color change. Moreover, an upper limit of the average particle size within the above range further increases the amount of color change.

In the present specification, the above average particle size is calculated from the line widths of scattering peaks measured with an automated multipurpose X-ray diffractometer (product name: Ultima IV, produced by Rigaku Corporation).

The nanoparticles for photochromic materials of the present invention described above make it possible to produce photochromic materials in which the reaction time of a photochromic reaction is short. In photochromic materials produced using the nanoparticles for photochromic materials of the present invention, the reaction time from irradiation with light to coloration and from coloration to returning to the original state is short; thus, products such as eyewear produced using the nanoparticles for photochromic materials of the present invention have a short time to reach a state suitable for a situation. Therefore, the nanoparticles for photochromic materials of the present invention can be suitably used for photochromic materials.

### 2. Aqueous Dispersion of Nanoparticles for Photochromic Materials

The aqueous dispersion of nanoparticles for photochromic materials of the present invention comprises the above-described nanoparticles for photochromic materials dispersed in water. By using the aqueous dispersion in which the nanoparticles for photochromic materials are dispersed in water, the reaction time of the photochromic reaction of the nanoparticles for photochromic materials in the aqueous dispersion becomes very short, and extremely fast photochromism can be exhibited.

The content of the nanoparticles for photochromic materials in the aqueous dispersion of nanoparticles for photochromic materials is preferably 0.1 to 30 mass %, more preferably 0.3 to 20 mass %, even more preferably 0.5 to 10 mass %, and particularly preferably 1.0 to 7 mass %, based on the aqueous dispersion taken as 100 mass %. A lower limit of the content of the nanoparticles for photochromic materials within the above range further improves the color development characteristics.

The temperature of the aqueous dispersion of nanoparticles for photochromic materials is preferably 0 to 50° C., and more preferably 0 to 30° C. A lower limit of the temperature of the aqueous dispersion of nanoparticles for photochromic materials within the above range further increases the amount of color development. An upper limit of the temperature of the aqueous dispersion of nanoparticles for photochromic materials within the above range further shortens the reaction time of the photochromic reaction of the nanoparticles for photochromic materials in the aqueous dispersion.

### 3. Method for Producing Nanoparticles for Photochromic Materials

The method for producing the nanoparticles for photochromic materials of the present invention is not particularly limited. For example, when the nanoparticles for photochromic materials are doped with a transition metal, they can be produced by the following production method 1. Production method for the nanoparticles for photochromic materials, comprising:
(1) step 1 of adding a zinc-containing compound, a doping metal source, and a sulfur-containing compound to a solvent to prepare a solution; and
(2) step 2 of adding a Group 16 element-containing compound to the solution, and heating the mixture.

The production method is described below.

### Step 1

Step 1 is a step of adding a zinc-containing compound, a doping metal source, and a sulfur-containing compound to a solvent to prepare a solution.

The solvent is not particularly limited as long as it is capable of dissolving the zinc-containing compound, the doping metal source, and the sulfur-containing compound; and examples thereof include water, octadecene, toluene, oleic acid, and the like. Among these, water and toluene are preferable, and water is more preferable, because the compound can be synthesized at a low temperature.

The zinc-containing compound is not particularly limited as long as it is soluble in a solvent, and examples thereof include zinc acetate (Zn(CH₃COO)₂), zinc nitrate (ZnNO₃), zinc chloride (ZnCl₂), zinc (Zn), and the like. Among these, zinc acetate is preferable because it is more easily dissolved in a solvent.

The zinc-containing compounds may be used singly, or in a combination of two or more.

The amount of the zinc-containing compound in the solution is preferably 0.1 to 1.5 mass %, and more preferably 0.3 to 0.8 mass %, based on the solution taken as 100 mass %. A lower limit of the amount of the zinc-containing compound within the above range further improve the yield of the nanoparticles for photochromic materials. Moreover, an upper limit of the amount of the zinc-containing compound within the above range further increases the amount of color change.

The doping metal source is not particularly limited as long as it contains a transition metal with which Zn can be substituted; and examples thereof include bis (acetylacetonato)copper (II) (Cu (C₅H₇O₂)₂) copper chloride (CuCl₂), copper sulfate (CuSO₄), copper nitrate (CuNO₃), and the like. Among these, bis(acetylacetonato)copper (II) and copper nitrate (CuNO₃) are preferable, and bis(acetylacetonato)copper (II) is more preferable, because the coloration upon irradiation with light is much more distinct.

The doping metal sources may be used singly, or in a combination of two or more.

The amount of the doping metal source in the solution is preferably 0.001 to 0.05 mass %, and more preferably 0.005 to 0.03 mass %, based on the solution taken as 100 mass %. A lower limit of the amount of the doping metal source within the above range further improves the yield of the nanoparticles for photochromic materials. Moreover, an upper limit of the amount of the doping metal source within the above range further increases the amount of color change.

In step 1, the sulfur-containing compound is a ligand source for forming the ligands of the nanoparticles for photochromic materials of the present invention described above.

The sulfur-containing compound is not particularly limited as long as it is soluble in a solvent; and examples thereof include 3-mercaptopropionic acid (MPA), thioglycolic acid (TGA), 11-mercaptoundecanoic acid, 4-mercaptobenzoic acid, and the like. Among these, 3-mercaptopropionic acid (MPA) and thioglycolic acid (TGA) are preferable, and 3-mercaptopropionic acid (MPA) is more preferable, because the coloration upon irradiation with light is much more distinct.

The sulfur-containing compounds may be used singly, or in a combination of two or more.

The amount of the sulfur-containing compound in the solution is preferably 0.5 to 5 mass %, and more preferably 1 to 3 mass %, based on the solution taken as 100 mass %. A lower limit of the amount of the sulfur-containing compound within the above range further improves the yield of the nanoparticles for photochromic materials. Moreover, an upper limit of the amount of the sulfur-containing compound within the above range further increases the amount of color change.

In step 1, other additives may be added to the solvent. Examples of the other additives include pH adjusters.

In step 1, the pH of the solution is preferably 8 or more, and more preferably 9 or more. A lower limit of the pH of the solution within the above range further improves the yield of the nanoparticles for photochromic materials. The upper limit of the pH of the solution is not particularly limited, and may be about 10.

Examples of pH adjusters for adjusting the pH of the solution to the above range include sodium hydroxide (NaOH), potassium hydroxide (KOH), and the like. Among these, sodium hydroxide (NaOH) can be preferably used.

In step 1, the lower limit of the temperature of the solution is preferably 0° C., and more preferably 20° C. A lower limit of the temperature of the solution within the above range further improves the yield of the nanoparticles for photochromic materials. The upper limit of the temperature of the solution is not particularly limited, and may be equal to or lower than the boiling point of the solvent.

The reaction time in step 1 is not particularly limited, and is preferably 5 minutes or more, and more preferably 10 minutes or more. A lower limit of the reaction time within the above range further improves the yield of the nanoparticles for photochromic materials. The upper limit of the reaction time is not particularly limited, and is about 1 hour.

In step 1, it is preferable to stir the solution in the above temperature range. The reaction efficiency in step 1 is further improved by stirring.

The solution to be used in step 2 is prepared by step 1 described above.

### Step 2

Step 2 is the step of adding a Group 16 element-containing compound to the solution and heating the mixture.

Examples of the Group 16 element contained in the Group 16 element-containing compound include O, S, Se, and Te. Among these, S and O are preferable, and S is more preferable, because the coloration upon irradiation with light is much more distinct.

The Group 16 element-containing compound is not particularly limited, and examples thereof include Na₂S, S, and the like. Among these, Na₂S is preferable because the coloration upon irradiation with light is much more distinct.

The amount of the Group 16 element-containing compound added is preferably 0.05 to 1 mass %, and more preferably 0.1 to 0.5 mass %, based on the solution after adding the Group 16 element-containing compound taken as 100 mass %. A lower limit of the amount of the Group 16 element-containing compound within the above range further improves the yield of the nanoparticles for photochromic materials. Moreover, an upper limit of the amount of the Group 16 element-containing compound within the above range further increases the amount of color change.

In step 2, the solution to which the Group 16 element-containing compound has been added is heated. In step 2, the lower limit of the temperature of the solution is preferably 50° C., and more preferably 70° C. A lower limit of the temperature of the solution within the above range further improves the yield of the nanoparticles for photochromic materials. The upper limit of the temperature of the solution is not particularly limited. In step 2, it is more preferable to heat the solution at the boiling point of the solvent.

The reaction time in step 2 is not particularly limited, and is preferably 2 hours or more, and more preferably 8 hours or more. A lower limit of the reaction time within the above range further improves the yield of the nanoparticles for photochromic materials. The upper limit of the reaction time is not particularly limited, and is preferably 48 hours or less, and more preferably 24 hours or less.

In step 2, it is preferable to stir the solution vigorously. The reaction efficiency in step 2 is further improved by stirring the solution vigorously.

Nanoparticles for photochromic materials are produced by step 2 described above.

### Step 3

Production method 1 for the nanoparticles for photochromic materials described above may comprise step 3 of, after step 2, adding the nanoparticles for photochromic materials obtained in step 2 to a poor solvent to aggregate the nanoparticles in a dispersion medium and performing centrifugation. By step 3, the size of the resulting nanoparticles for photochromic materials is increased, allowing the nanoparticles for photochromic materials having the desired average particle size to be prepared.

The dispersion medium is not particularly limited, and examples of usable dispersion media include water and the like.

The poor solvent is not particularly limited, and examples thereof include alcohols, such as ethanol, methanol, propanol, and isopropanol; and polar organic solvents, such as acetone and acetonitrile. Among these, alcohols are preferable, and ethanol is more preferable, because water can be used as a dispersion medium.

In step 3, the nanoparticles for photochromic materials are aggregated in the dispersion medium to which the nanoparticles for photochromic materials have been added by allowing the dispersion medium to stand. The temperature of the dispersion medium to which the nanoparticles for photochromic materials have been added, while standing, is preferably 0 to 30° C., and more preferably 15 to 25° C. A temperature of the dispersion medium to which the nanoparticles for photochromic materials have been added within the above range allows the nanoparticles for photochromic materials to be more easily aggregated.

The standing time of the solvent to which the nanoparticles for photochromic materials have been added in step 3 is not particularly limited, and is preferably 30 seconds or more, and more preferably 1 minute or more. A lower limit of the reaction time within the above range further improves the yield of the nanoparticles for photochromic materials. The upper limit of the reaction time is not particularly limited, and is about 1 hour. An upper limit of the reaction time within the above range allows the nanoparticles for photochromic materials to be more easily redispersed in water.

Moreover, when a transition metal is adsorbed to the nanoparticles for photochromic materials, the nanoparticles for photochromic materials of the present invention can be produced by the following production method 2.

Production method 2 for the nanoparticles for photochromic materials, comprising:
(1) step 1′ of adding a zinc-containing compound and a sulfur-containing compound to a solvent to prepare a solution;
(2) step 2′ of adding a Group 16 element-containing compound to the solution, and heating the mixture to prepare a dispersion of nanoparticles for photochromic materials to which no transition metal is adsorbed; and
(3) step 3′ of adding a transition metal source to the dispersion to adsorb the transition metal on the surface of the nanoparticles for photochromic materials to which no transition metal is adsorbed.

The production method is described below.

### Step 1′

Step 1′ is a step of adding a zinc-containing compound and a sulfur-containing compound to a solvent to prepare a solution.

In step 1′, a solution is prepared without adding a doping metal source to a solvent in step 1 of production method 1, which is a method for the nanoparticles for photochromic materials that are doped with a transition metal. Specifically, examples of the solvent, zinc-containing compound, and sulfur-containing compound in step 1′ are the same as those mentioned as examples of the solvent, zinc-containing compound, and sulfur-containing compound in step 1 of production method 1. In step 1′, the solution is prepared in the same manner as in step 1 of production method 1, except that no doping metal source is added to the solvent.

### Step 2′

Step 2′ is a step of adding a Group 16 element-containing compound to the solution, and heating the mixture to prepare a dispersion of nanoparticles for photochromic materials to which no transition metal is adsorbed. Step 2′ is the same as step 2 in production method 1.

### Step 3′

Step 3′ is a step of adding a transition metal source to the dispersion to adsorb the transition metal on the surface of the nanoparticles for photochromic materials to which no transition metal is adsorbed. By adding a transition metal source to the dispersion prepared in step 2′, the transition metal is adsorbed on the surface of the particle core represented by ZnX in the dispersion. In step 3′, the particle core represented by ZnX may be doped with some of the transition metal; and the nanoparticles for photochromic materials of the present invention may be in a state in which the nanoparticles are doped with and/or have, adsorbed thereto, the transition metal.

The transition metal source used can be the same as the doping metal source in step 1 in production method 1.

The amount of the transition metal source added is preferably 0.01 to 0.5 mass %, and more preferably 0.05 to 0.3 mass %, based on the dispersion taken as 100 mass %. A lower limit of the amount of the transition metal source within the above range further improves the yield of the nanoparticles for photochromic materials. Moreover, an upper limit of the amount of the transition metal source within the above range further increases the amount of color change.

In step 3′, the lower limit of the temperature of the dispersion is preferably 0° C., and more preferably 20° C. A lower limit of the temperature of the dispersion within the above range further improves the yield of the nanoparticles for photochromic materials. The upper limit of the temperature of the dispersion is not particularly limited, and may be equal to or lower than the boiling point of the solvent.

The reaction time in step 3′ is not particularly limited, and is preferably 5 minutes or more, and more preferably 10 minutes or more. A lower limit of the reaction time within the above range further improves the yield of the nanoparticles for photochromic materials. The upper limit of the reaction time is not particularly limited, and is about 1 hour.

In step 3′, it is preferable to stir the dispersion in the above temperature range. The reaction efficiency in step 3′ is further improved by stirring.

### Step 4′

Production method 2 for the nanoparticles for photochromic materials described above may comprise step 4′ of, after step 3′, adding the nanoparticles for photochromic materials obtained in step 3′ to a poor solvent to aggregate the nanoparticles in a dispersion medium, and performing centrifugation. By step 4′, unreacted starting materials and side reaction products can be removed, and nanoparticles for photochromic materials with even higher purity can be prepared.

The dispersion medium and poor solvent used can be the same as those in step 3 in production method 1.

In step 4′, the nanoparticles for photochromic materials are aggregated in the dispersion medium to which the nanoparticles for photochromic materials have been added by allowing the dispersion medium to stand. The temperature of the dispersion medium to which the nanoparticles for photochromic materials have been added, while standing, is preferably 0 to 30° C., and more preferably 15 to 25° C. A temperature of the dispersion medium to which the nanoparticles for photochromic materials have been added within the above range allows the nanoparticles for photochromic materials to be more easily aggregated.

The standing time of the solvent to which nanoparticles for photochromic materials have been added in step 4′ is not particularly limited, and is preferably 30 seconds or more, and more preferably 1 minute or more. A lower limit of the reaction time within the above range further improves the yield of the nanoparticles for photochromic materials. The upper limit of the reaction time is not particularly limited, and is about 1 hour. An upper limit of the reaction time within the above range allows the nanoparticles for photochromic materials to be more easily redispersed in water.

### EXAMPLES

The present invention is described in more detail below with reference to Examples and Comparative Examples; however, the present invention is not limited to these Examples.

### Example 1

### Step 1

100 ml of water was poured into a flask, and 547 mg of zinc acetate (Zn(CH₃COO)₂), 7 mg of bis(acetylacetonato)copper (II) (Cu(C₅H₇O₂)₂), and 1 mL of 3-mercaptopropionic acid (MPA) were added.

Subsequently, sodium hydroxide (NaOH) was added as a pH adjuster with stirring to prepare a solution. The pH of the solution was 10.

The solution was flushed with nitrogen gas with stirring at room temperature for 30 minutes to remove the gas produced from the solution.

### Step 2

276 mg of Na₂S, which is a Group 16 element-containing compound, was added while the solution prepared in step 1 was stirred vigorously. Subsequently, the solution to which Na₂S was added was heated at 100° C. for 24 hours to prepare nanocrystals of nanoparticles for photochromic materials.

Ethanol was added to the nanocrystals of nanoparticles for photochromic materials to aggregate the nanoparticles for photochromic materials. The photochromic material was precipitated with a centrifuge to obtain the nanoparticles for photochromic materials. The doping amount of elemental Cu in the nanoparticles for photochromic materials was 1 mol % based on the total number of moles of elemental Zn and elemental Cu taken as 100 mol %.

The average particle size of the obtained nanoparticles for photochromic materials was calculated from the line widths of scattering peaks measured with an automated multipurpose X-ray diffractometer (product name: Ultima IV, produced by Rigaku Corporation).

### Example 2

Nanoparticles for photochromic materials were obtained in the same manner as in Example 1, except that the amount of bis(acetylacetonato)copper (II) (Cu (C₅H₇O₂)₂) added was changed, and the doping amount of elemental Cu in the nanoparticles for photochromic materials was 3%.

### Comparative Example 1

Nanoparticles for photochromic materials were obtained in the same manner as in Example 1, except that bis(acetylacetonato)copper (II) (Cu (C₅H₇O₂)₂) was not added, and the doping amount of elemental Cu in the nanoparticles for photochromic materials was 0%.

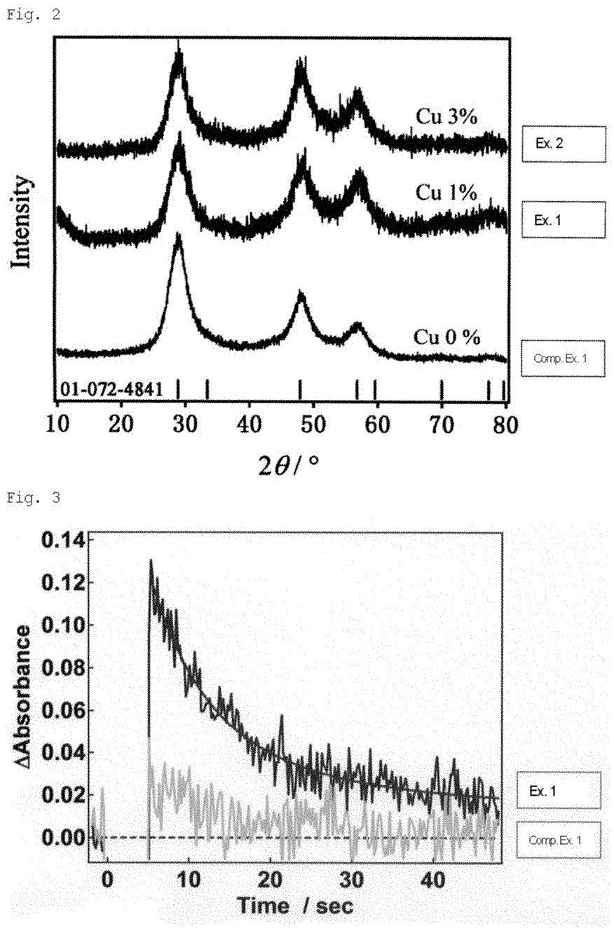

The XRD (X-ray diffraction) of the obtained nanoparticles for photochromic materials was calculated from the line widths of the scattering peaks with an XRD measuring device (product name: Ultima IV, produced by Rigaku Corporation). FIG. 2 shows the results.

The results in FIG. 2 show that the nanoparticles for photochromic materials obtained in Example 1, Example 2, and Comparative Example 1 have a cubic crystal structure.

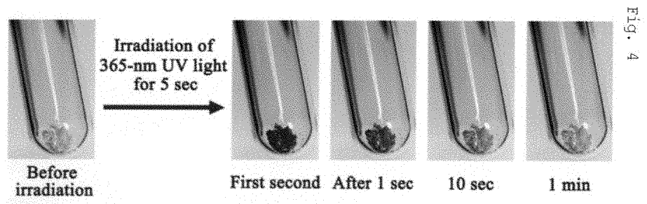

The nanoparticles for photochromic materials obtained in Example 1 and Comparative Example 1 were irradiated with ultraviolet light (wavelength: 365 nm; 17.5 mW/cm²) for 5 seconds, and the absorbance change in a 500 nm spectrum was measured with an absorption spectrometer (product name: Ocean FX, produced by Ocean Optics). FIG. 3 shows the results. FIG. 4 shows photographs of the state of the nanoparticles for photochromic materials of Example 1.

The results in FIGS. 3 and 4 show that the nanoparticles for photochromic materials of Example 1 were colored when irradiated with ultraviolet light for 5 seconds, and returned to the original state after about 1 minute.

In contrast, the results show that the nanoparticles for photochromic materials of Comparative Example 1 were hardly colored even when irradiated with ultraviolet light.

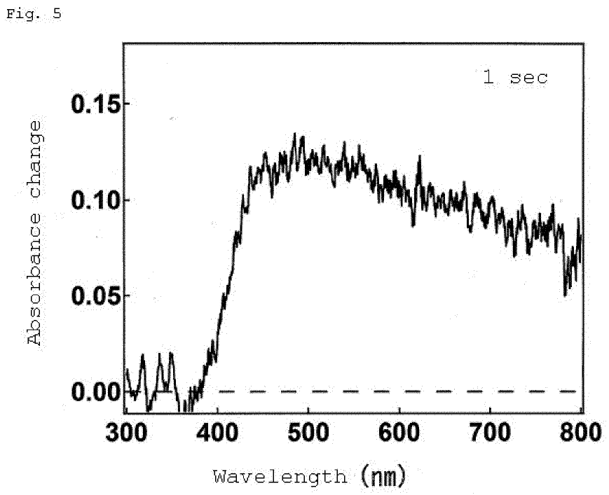

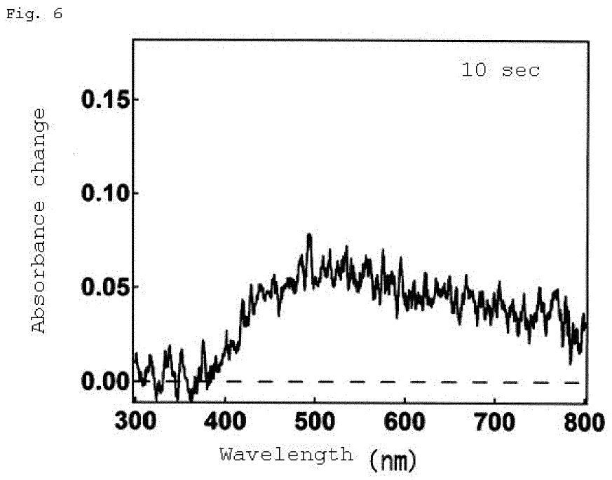

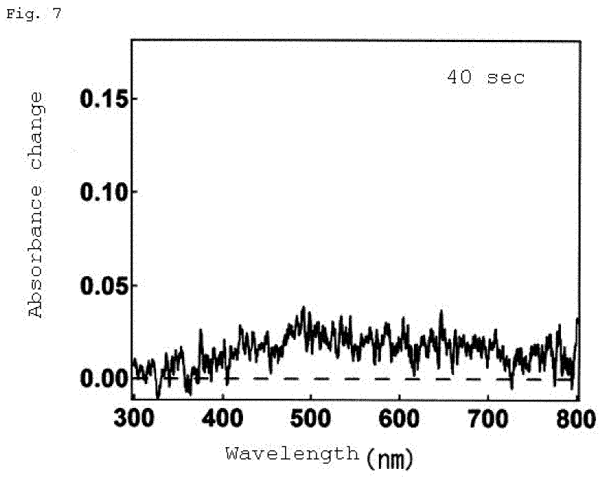

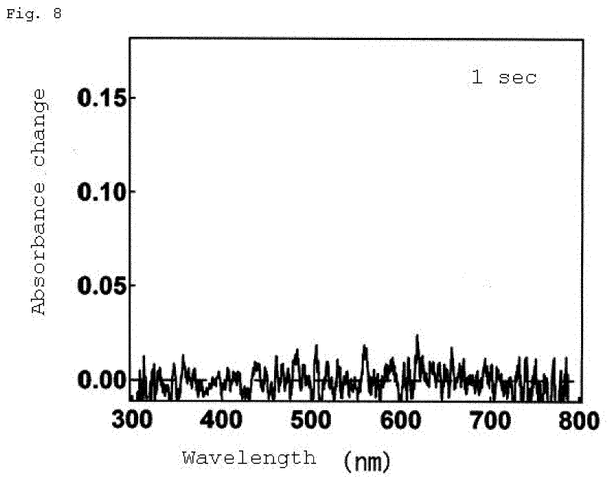

The nanoparticles for photochromic materials obtained in Example 1 were irradiated with ultraviolet light (wavelength: 365 nm; 17.5 mW/cm²) for 5 seconds, and the absorption of ultraviolet light was measured by the absorbance change in spectra in the range of 300 to 800 nm using an absorption spectrometer (product name: Ocean FX, produced by Ocean Optics). FIG. 5 shows the results 1 second after the completion of ultraviolet light irradiation. FIG. 6 shows the results 10 seconds after the completion of ultraviolet light irradiation. FIG. 7 shows the results 40 seconds after the completion of ultraviolet light irradiation.

The results in FIGS. 5 to 7 show that the nanoparticles for photochromic materials of Example 1 were colored after ultraviolet light irradiation, and returned to the original state after about 40 seconds.

### Comparative Example 2

### Step 1

140 mL of water was poured into a flask, and 1536 mg of zinc acetate (Zn(CH₃COO)₂), 19.1 mg of bis(acetylacetonato)copper (II) (Cu(C₅H₇O₂)₂) and 0.63 mL of poly(ethylene glycol)bis(carboxymethyl)ether represented by the following formula were added, followed by heating to 100° C.

### Step 2

1310 mg of Na₂S, which is a Group 16 element-containing compound, was added while the solution prepared in step 1 was stirred vigorously. Subsequently, the solution to which Na₂S was added was heated at 100° C. for 24 hours to prepare nanocrystals of nanoparticles for photochromic materials. Thereafter, the photochromic material was precipitated with a centrifuge to obtain the nanoparticles for photochromic materials.

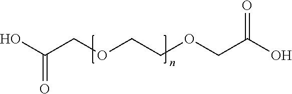

wherein n represents an integer of 1 or more.

### Comparative Example 3

### Step 1

100 mL of water was poured into a flask, and 547 mg of zinc acetate (Zn(CH₃COO)₂) and 7 mg of bis(acetylacetonato)copper (II) (Cu(C₅H₇O₂)₂) were added.

Subsequently, sodium hydroxide (NaOH) was added as a pH adjuster with stirring to prepare a solution. The pH of the solution was 10.

The solution was flushed with nitrogen gas with stirring at room temperature for 30 minutes to remove oxygen dissolved in the solution.

### Step 2

276 mg of Na₂S, which is a Group 16 element-containing compound, was added while the solution prepared in step 1 was stirred vigorously. Stirring was performed for 15 minutes to prepare nanoparticles for photochromic materials. The nanoparticles for photochromic materials were precipitated with a centrifuge, and prepared as a solid.

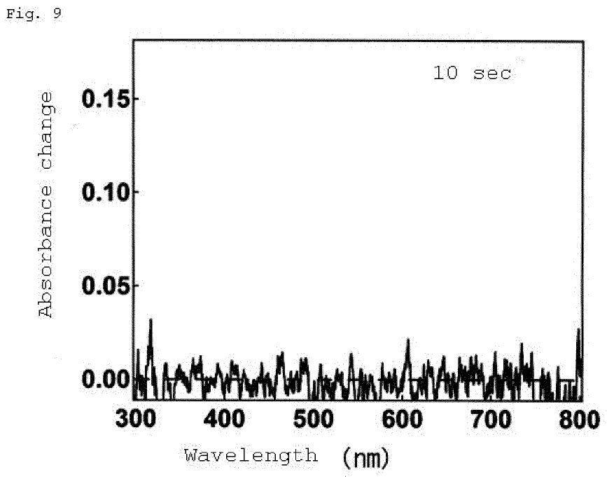

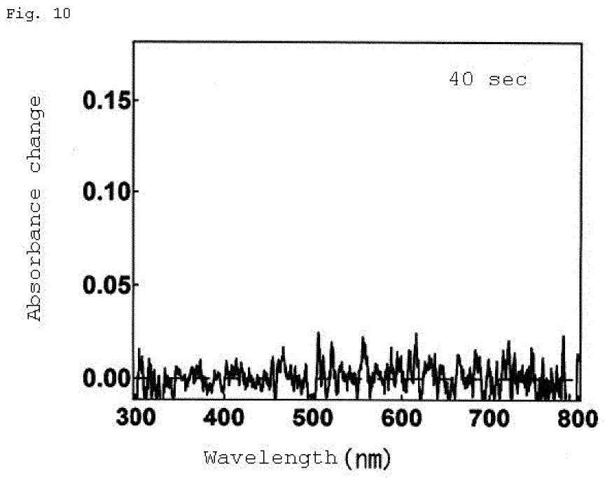

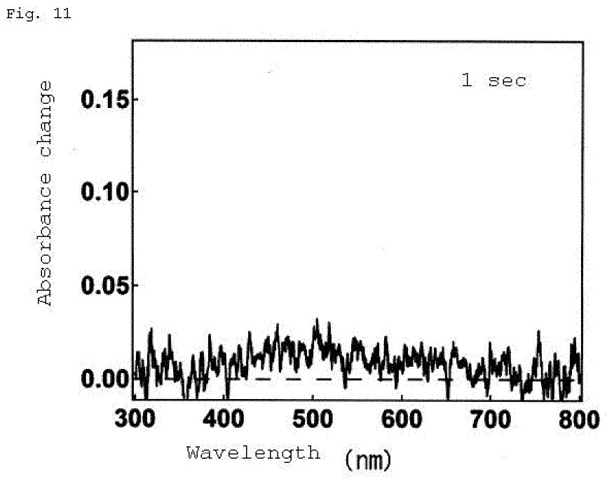

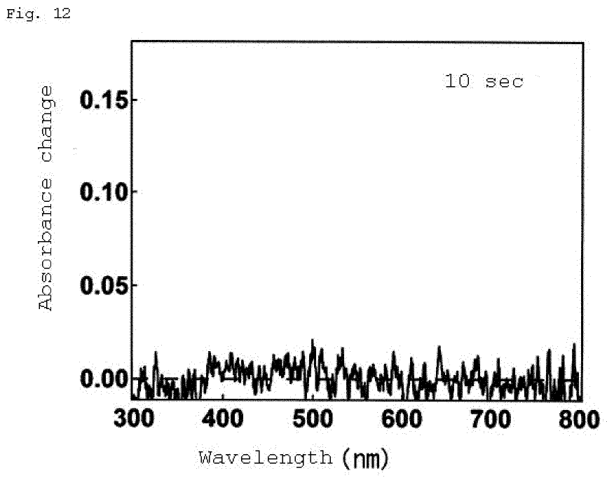

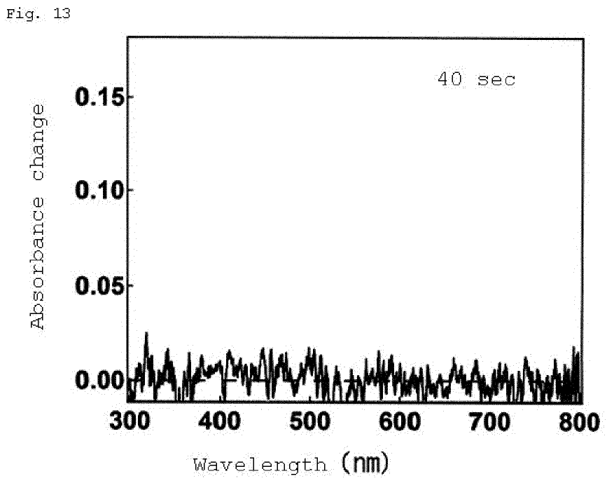

The nanoparticles for photochromic materials obtained in Comparative Example 2 and Comparative Example 3 were irradiated with ultraviolet light (wavelength: 365 nm; 17.5 mW/cm²) for 5 seconds, and the absorption of ultraviolet light was measured by the absorbance change in spectra in a range of 300 to 800 nm using an absorption spectrometer (product name: Ocean FX, produced by Ocean Optics). FIG. 8 shows the results 1 second after the completion of ultraviolet light irradiation in Comparative Example 2; FIG. 9 shows the results 10 seconds after the completion of ultraviolet light irradiation in Comparative Example 2; and FIG. 10 shows the results 40 seconds after the completion of ultraviolet light irradiation in Comparative Example 2. FIG. 11 shows the results 1 second after the completion of ultraviolet light irradiation in Comparative Example 3; FIG. 12 shows the results 10 seconds after the completion of ultraviolet light irradiation in Comparative Example 3; and FIG. 13 shows the results 40 seconds after the completion of ultraviolet light irradiation in Comparative Example 3.

The results in FIGS. 8 to 13 show that the nanoparticles for photochromic materials of Comparative Example 2 and Comparative Example 3 were hardly colored even when irradiated with ultraviolet light.

Example 3 below shows that even when a transition metal is doped into and/or adsorbed to non-transition metal-doped nanoparticles for photochromic materials to which no transition metal is adsorbed, after preparation of the nanoparticles for photochromic materials, by adding a transition metal source (transition metal ion) to a dispersion of the nanoparticles for photochromic materials, a photochromic reaction is exhibited as in the case in which nanoparticles for photochromic materials are doped with a transition metal during the synthesis of the nanoparticles.

### Example 3

20 mg of the nanoparticles for photochromic materials (ZnS nanoparticles) prepared in Comparative Example 1, which are not doped with Cu, were dispersed in 0.5 mL of water to prepare an aqueous dispersion. 0.5 mg of bis(acetylacetonato)copper (II) (Cu(C₅H₇O₂)2) was separately dissolved in 2 mL of water to prepare an aqueous solution. The aqueous Cu(C₅H₇O₂)₂ solution was added to the aqueous dispersion of the nanoparticles for photochromic materials to prepare a mixture, and the mixture was stirred at room temperature for about 2 minutes. The amount of Cu(C₅H₇O₂)₂ added was 2.4 mass % based on the mixture taken as 100 mass %. Subsequently, ethanol was added to the mixture, and nanoparticles for photochromic materials were obtained by precipitating the nanoparticles for photochromic materials with a centrifuge. The obtained nanoparticles for photochromic materials exhibited photochromism by ultraviolet light irradiation (365 nm) in the same manner as nanoparticles for photochromic materials doped with Cu during synthesis.

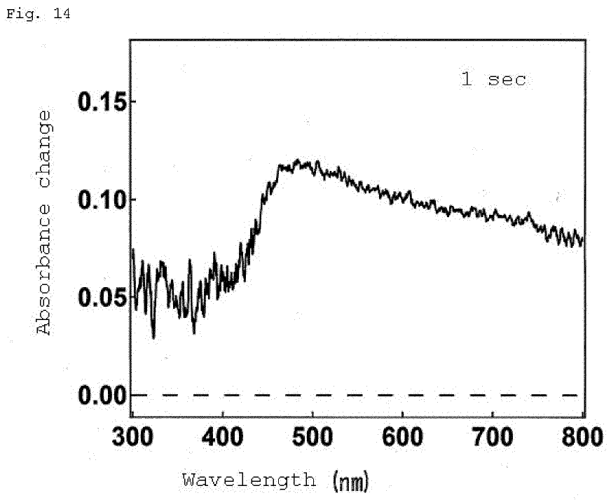

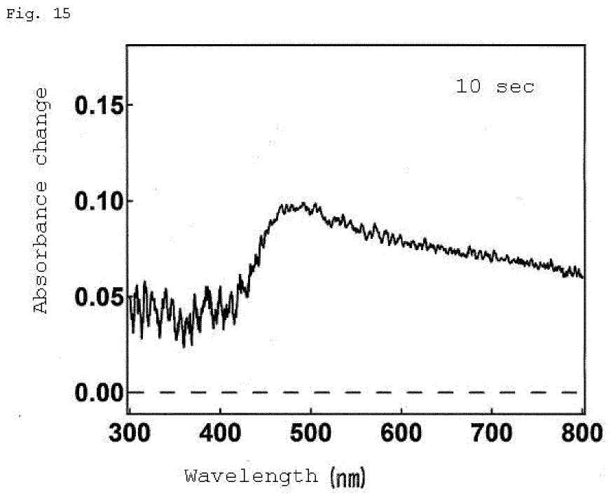

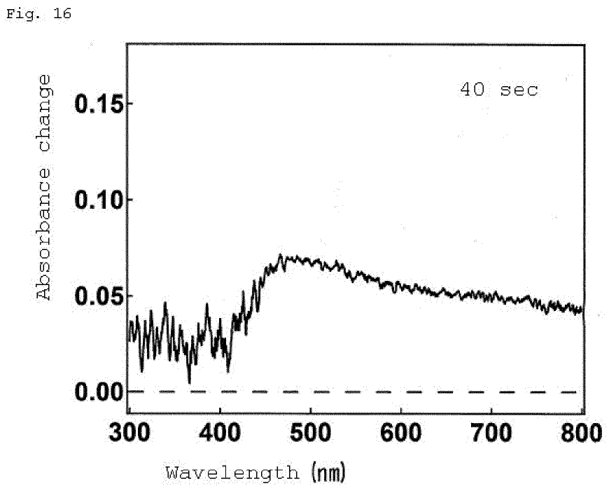

The nanoparticles for photochromic materials obtained in Example 3 were irradiated with ultraviolet light (wavelength: 365 nm; 17.5 mW/cm²) for 5 seconds, and the absorption of ultraviolet light was measured by the absorbance change in spectra in the range of 300 to 800 nm using an absorption spectrometer (product name: Ocean FX, produced by Ocean Optics). FIG. 14 shows the results 1 second after the completion of ultraviolet light irradiation. FIG. 15 shows the results 10 seconds after the completion of ultraviolet light irradiation. FIG. 16 shows the results 40 seconds after the completion of ultraviolet light irradiation.

The results in FIGS. 14 to 16 show that in Example 3, the nanoparticles for photochromic materials were colored after ultraviolet light irradiation, and the absorbance change decreased after about 40 seconds.

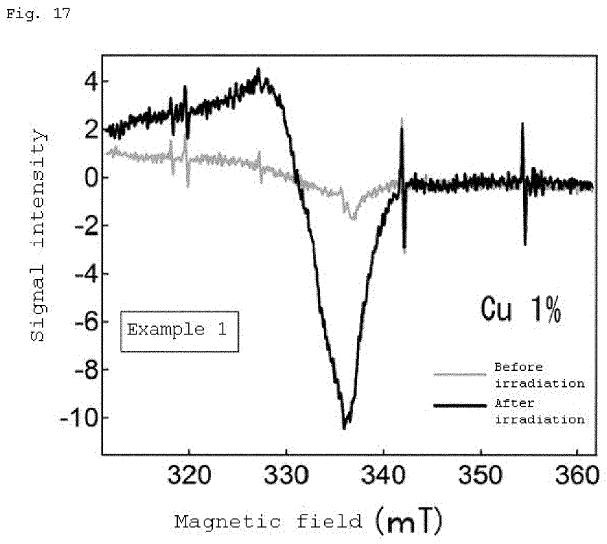

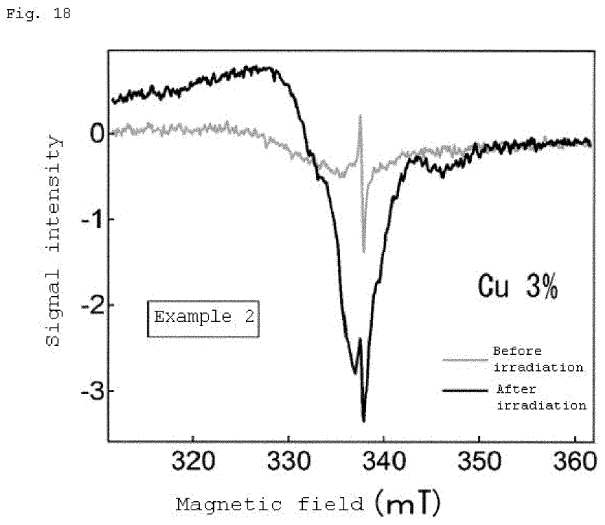

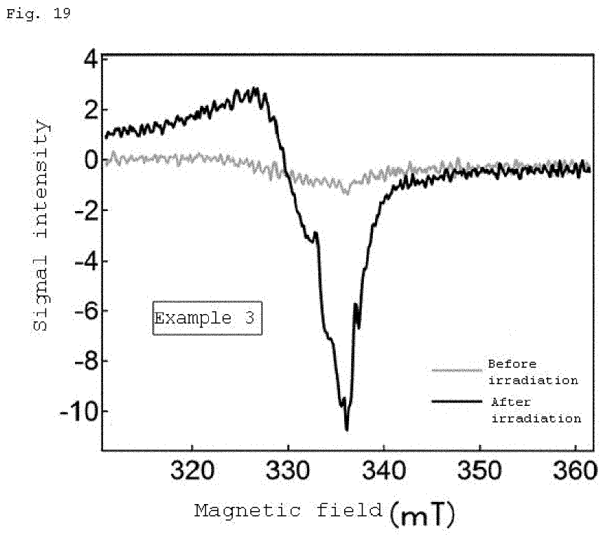

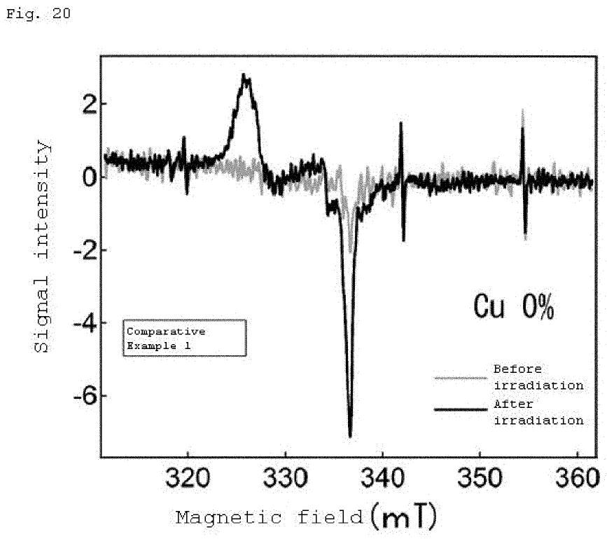

The electron paramagnetic resonance (EPR) of the samples prepared in Examples 1 to 3 and Comparative Example 1 was measured before and after ultraviolet light irradiation. Specifically, each sample was degassed in a quartz tube. X-band EPR measurement was performed at 77 K using a Bruker EMX system. The sample was excited by 365 nm LED light (THORLABS, M365LP1). Electron paramagnetic resonance (EPR) was measured under the conditions of 0.3 mW microwave power and 0.4 mT modulation amplitude. FIG. 17 shows the results of Example 1. FIG. 18 shows the results of Example 2. FIG. 19 shows the results of Example 3. FIG. 20 shows the results of Comparative Example 1.

The results in FIGS. 17 to 19 show that in Examples 1 to 3, no signal derived from Cu²⁺ was observed before ultraviolet light irradiation, indicating that the Cu contained in the nanoparticles was Cu⁺. Broad Cu²⁺-derived peaks were observed at the upper and lower portions of the charts in the magnetic field region of 340 mT or less after ultraviolet light irradiation, confirming that Cu⁺ was oxidized to Cu²⁺ by ultraviolet light irradiation. In contrast, the results in FIG. 20 show that in Comparative Example 1, only sharp S radical anion peaks were observed at the upper and lower portions of the chart after ultraviolet light irradiation.

### Absorption Spectrum Change in Aqueous Dispersion

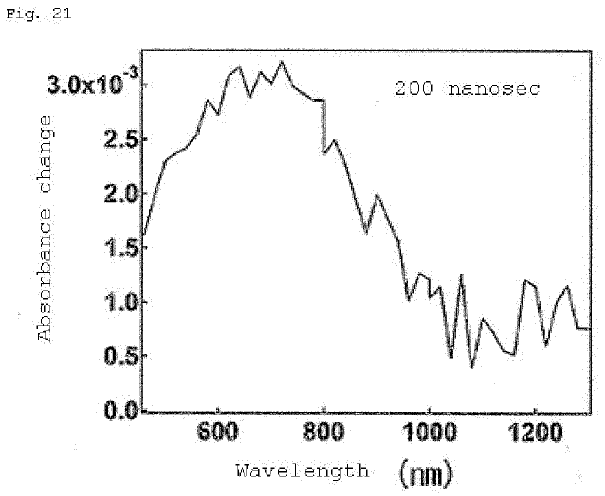

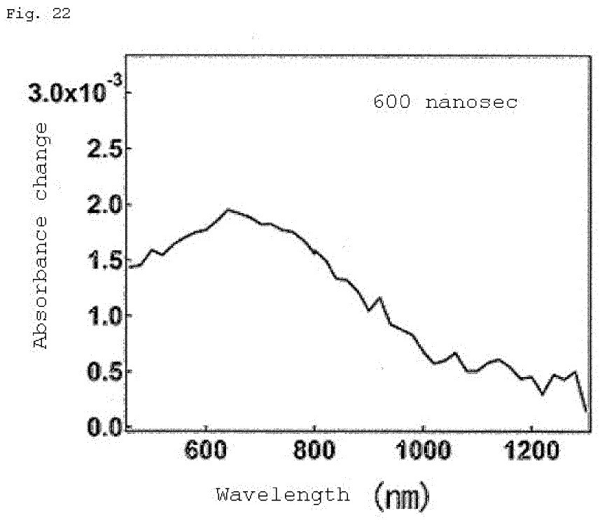

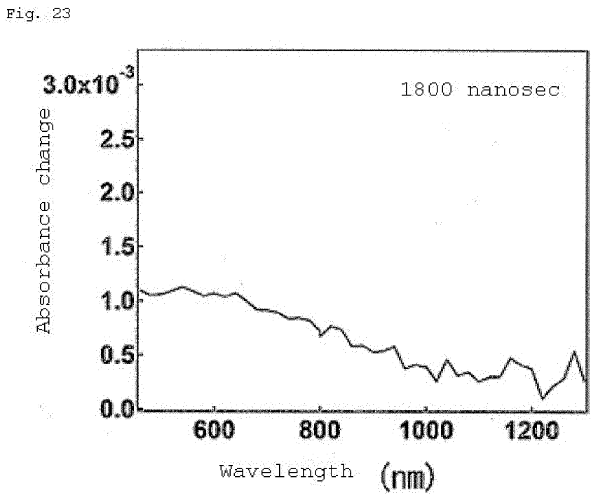

The nanoparticles for photochromic materials prepared in Example 2 were dispersed in water to prepare an aqueous dispersion. The content of the nanoparticles for photochromic materials in the aqueous dispersion was 2.9 mass % based on the aqueous dispersion taken as 100 mass %. The temperature of the aqueous dispersion was about 25° C. The absorption spectrum change (transient absorption spectrum) in a short time domain that cannot be observed visually was measured using the aqueous dispersion. The measurement was performed using picoTAS by a randomly interleaved pulse train (RIPT) method in cooperation with Unisoku Co., Ltd. A 355 nm picosecond pulsed laser was used for excitation light. The intensity of the picosecond pulsed laser was 20 μJ/pulse. FIG. 21 shows the results 200 nanoseconds after the completion of irradiation with the picosecond pulsed laser. FIG. 22 shows the results 600 nanoseconds after the completion of irradiation with the picosecond pulsed laser. FIG. 23 shows the results 1800 nanoseconds after the completion of irradiation with the picosecond pulsed laser.

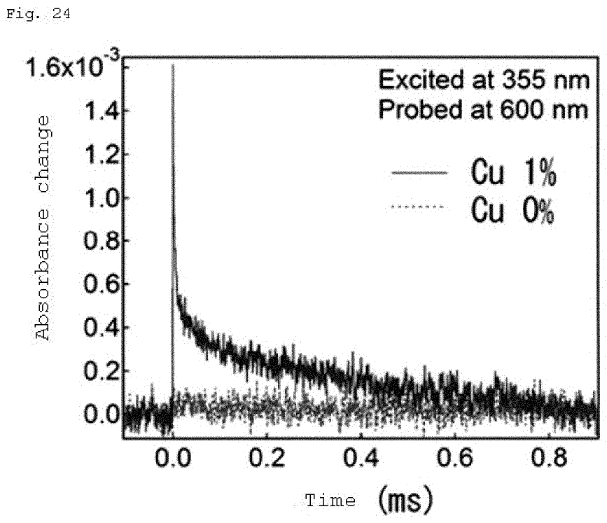

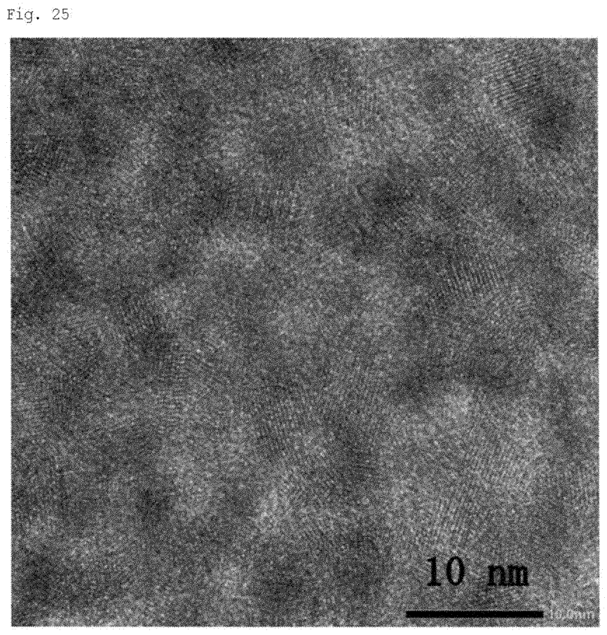

The nanoparticles for photochromic materials (Cu: 1%) prepared in Example 1 and the nanoparticles for photochromic materials (Cu: 0%) prepared in Comparative Example 1 were individually dispersed in water in the same manner as the nanoparticles for photochromic materials of Example 2 above to prepare aqueous dispersions, and the transient absorption spectra were measured. FIG. 24 shows the measurement results of absorbance changes probed at a wavelength of 600 nm.

The results in FIGS. 21 to 24 show that broad absorption was observed from visible light to near-infrared region immediately after light excitation. This absorption spectral shape is slightly different from the absorption spectra observed on a long time scale of the order of seconds. An absorption band thereof was attenuated in about one microsecond, and an absorption band with a different spectral shape was observed. After that, the absorption band continued to be observed for not less than hundreds of microseconds, suggesting that this absorption band was an absorption band observed as coloration change in the solid. This phenomenon was observed repeatedly, and the nanoparticles for photochromic materials (ZnS nanoparticles doped with Cu) prepared in Example 2 were found to exhibit extremely fast photochromism in the aqueous dispersion. It was also found that larger absorption change was induced in the fast time domain of the order of microseconds.

The results in FIG. 24 show that the aqueous dispersion prepared by dispersing the nanoparticles for photochromic materials (Cu: 1%) obtained in Example 1 in water exhibited extremely fast photochromism in the aqueous dispersion. In contrast, it was confirmed that the aqueous dispersion prepared by dispersing the nanoparticles for photochromic materials (Cu: 0%) obtained in Comparative Example 1, which are not doped with elemental Cu, in water did not exhibit photochromism in the aqueous dispersion.

### TEM Observation of Nanoparticles for Photochromic Materials

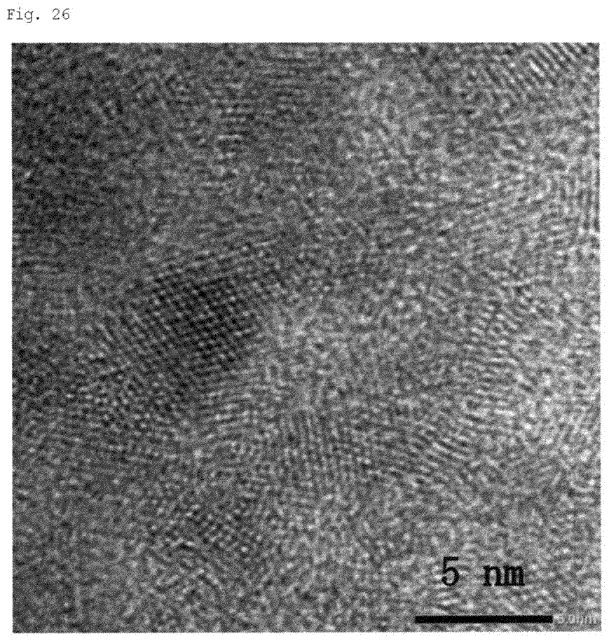

The nanoparticles for photochromic materials prepared in Example 2 were observed with a transmission electron microscope (TEM). The observation was performed at an acceleration voltage of 200 kV using a JEM-2100Plus transmission electron microscope (produced by JEOL Ltd). Specifically, the nanoparticles for photochromic materials prepared in Example 2 were dispersed in water to prepare a dispersion. A grid was immersed in the dispersion to attach the nanoparticles, and TEM images were taken to measure the average particle size of the nanoparticles for photochromic materials. FIGS. 25 and 26 show the results. In the TEM images shown in FIGS. 25 and 26, the nanoparticles for photochromic materials were observed as dark black clumps. The average particle size of the nanoparticles for photochromic materials was about 4 nm, which was slightly larger than that in XRD measurement.

### Light Resistance of Nanoparticles for Photochromic Materials

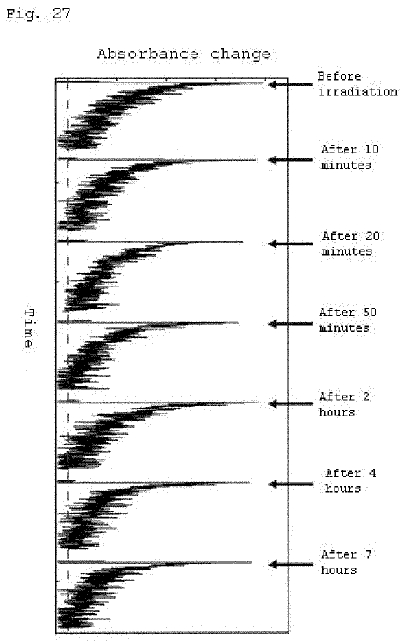

The nanoparticles for photochromic materials (solid) prepared in Example 1 were irradiated with ultraviolet light (wavelength: 365 nm; intensity: 6.5 mW/cm²) for a long period of time, and the absorbance change was measured. Specifically, the nanoparticles for photochromic materials prepared in Example 1 were irradiated with the above-mentioned ultraviolet light for 7 hours, and the absorbance change was measured. The ultraviolet light irradiation was temporarily stopped at each of the following time points: before the ultraviolet light irradiation, after 10 minutes, after 20 minutes, after 50 minutes, after 2 hours, after 4 hours, and after 7 hours, to measure the absorbance change. In the absorbance change measurement, the nanoparticles for photochromic materials were irradiated with ultraviolet light (wavelength: 365 nm; 17.5 mW/cm²) for 5 seconds, and the absorption of ultraviolet light was measured by the absorbance change in spectra in the range of 300 to 800 nm using an absorption spectrometer (product name: Ocean FX, produced by Ocean Optics). FIG. 27 shows the results of absorbance change measurement probed at a wavelength of 600 nm at each time point.

The results in FIG. 27 show that even after irradiation with ultraviolet light for a long period of time, the nanoparticles for photochromic materials prepared in Example 1 exhibited a photochromic reaction at the same level as before irradiation, confirming that the nanoparticles exhibited light resistance.

### Absorption Spectrum Measurement of Nanoparticles for Photochromic Materials (Solid)

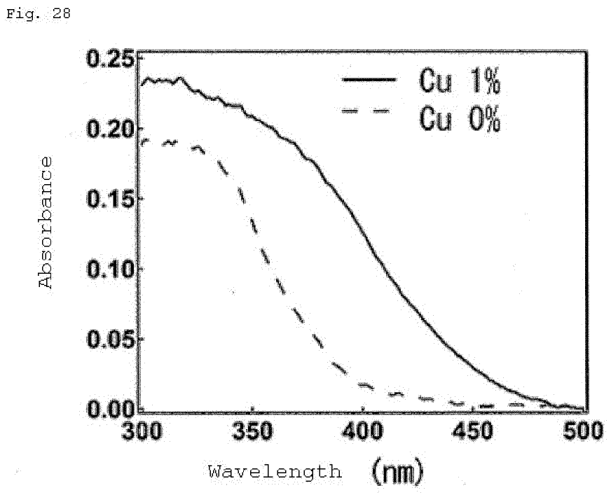

The absorption spectra of the nanoparticles for photochromic materials (solid) prepared in Example 1 (Cu: 1%) and Comparative Example 1 (Cu: 0%) were measured. The measurement was performed by measuring the absorbance change in spectra in the range of 300 to 500 nm using a spectrophotometer (HITACHI U-4100 (with an integrating sphere) produced by Hitachi High-Technologies Corporation). FIG. 28 shows the results.

The results in FIG. 28 show that in the nanoparticles for photochromic materials prepared in Example 1, the absorption shifted to the long-wavelength side due to doping with elemental Cu, and the optical sensitivity was extended to the visible light side compared with that of the nanoparticles for photochromic materials prepared in Comparative Example 1.

### Effect of Adsorbed Water on Surface of Nanoparticles for Photochromic Materials on Photochromism

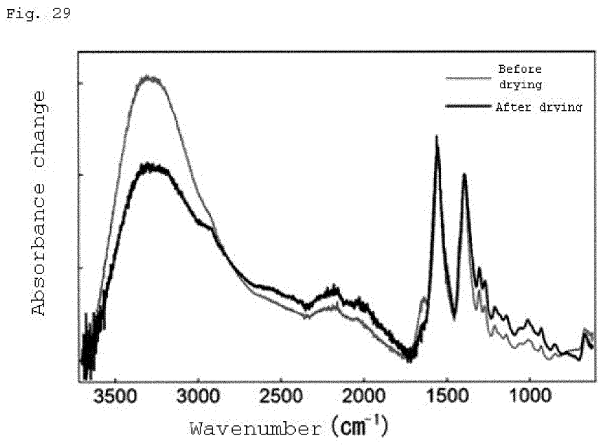

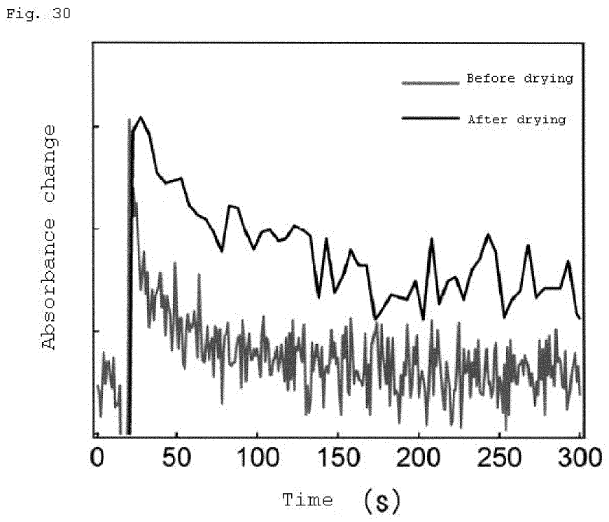

30 mg of the nanoparticles for photochromic materials prepared in Example 1 were placed in a vial and vacuum-dried at 60° C. for 2 hours. The IR spectra of the nanoparticles for photochromic materials before and after drying were measured. FIG. 29 shows the results. The nanoparticles for photochromic materials before and after drying were irradiated with ultraviolet light (wavelength: 365 nm; intensity: 17.5 mW/cm²), and the absorbance change was measured. FIG. 30 shows the results.

The results in FIG. 29 show that vacuum-drying of the nanoparticles for photochromic materials reduced the broad peak at a wavelength of 3500 to 3000 cm⁻¹ derived from the hydrogen bonding in the adsorbed water on the surface of the nanoparticles for photochromic materials in the IR spectra, indicating that the adsorbed water on the nanoparticles for photochromic materials was decreased. The results in FIG. 30 show that the nanoparticles for photochromic materials with adsorbed water on their surface (before drying) had an extremely high rate of decoloration after irradiation with ultraviolet light.

### Temperature Dependence of Photochromism of Nanoparticles for Photochromic Materials

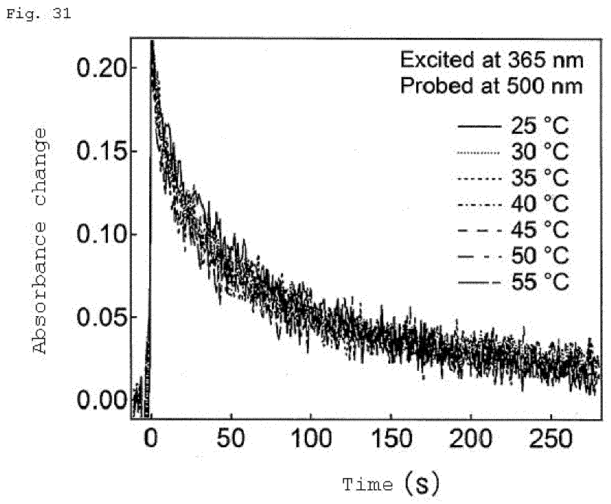

The absorbance decay of the nanoparticles for photochromic materials prepared in Example 1 under ultraviolet light irradiation was measured by increasing the measurement temperature in 5° C. increments in the temperature range of 25 to 55° C. FIG. 31 shows the results. The results show that there was little change in the amount of absorbance change and the decay rate due to the ultraviolet light irradiation, even when the temperature was changed in the temperature range of 25 to 55° C. Conventional photochromic materials, which show temperature dependence, have a problem in that under the above conditions of use, the photochromic reaction is too fast to achieve good color development, or is so slow that the materials cannot function as light-adjusting sunglasses. There are very few photochromic materials whose temperature dependence is suppressed, and such photochromic materials can exhibit photochromic properties without being restricted by season or location. Since the temperature dependence is suppressed in such photochromic materials, the photochromic materials can be used for sunglasses, for example, at beaches in midsummer or at ski resorts.

### INDUSTRIAL APPLICABILITY

The nanoparticles for photochromic materials of the present invention can be suitably used for eyewear, such as eyeglasses, sunglasses, and goggles; high-speed rewritable recording materials suitable for applications, such as animation holograms; materials for preventing counterfeit of credit cards, paper currency, brand-name products, etc.; and the like.

### DESCRIPTION OF THE REFERENCE NUMERALS

1. Nanoparticle for photochromic materials

2. ZnS nanoparticle

3. Transition metal

1. A nanoparticle for photochromic materials, the nanoparticle being represented by the following formula (1):
ZnX (1),
wherein X represents a Group 16 element,
the nanoparticle being doped with and/or having, adsorbed thereto, a transition metal,
the nanoparticle having organic ligands containing elemental sulfur on the surface thereof.

2. The nanoparticle for photochromic materials according to claim 1, wherein X is at least one member selected from the group consisting of O, S, Se, and Te.

3. The nanoparticle for photochromic materials according to claim 1, wherein the organic ligands are represented by the following formula (2):
—S—R—COOH (2),
wherein R represents a C₁-C₂₀ organic group.

4. The nanoparticle for photochromic materials according to claim 1, which has an average particle size of 1 nm or more and 100 nm or less.

5. An aqueous dispersion of nanoparticles for photochromic materials, comprising the nanoparticles for photochromic materials according to claim 1 dispersed in water.
